(19) United States
(12) Patent Application Publication
(10) Pub. No.: US 2024/0203021 A1
(43) Pub. Date: Jun. 20, 2024

(54) IMAGE PROCESSING DEVICE, IMAGE PROCESSING METHOD, AND PROGRAM

(71) Applicant: SONY GROUP CORPORATION, TOKYO (JP)

(72) Inventor: AKIRA UMAYABARA, TOKYO (JP)

(21) Appl. No.: 18/555,727

(22) PCT Filed: Feb. 1, 2022
(86) PCT No.: PCT/JP2022/003736

§ 371 Date: Oct. 17, 2023

(30) Foreign Application Priority Data
May 6, 2021 (JP) 2021-078536

(51) Int. Cl. G06T 15/00; G06T 5/50; G06T 7/70; G06V 10/74; H04N 13/279

(52) U.S. Cl. CPC G06T 15/00; G06T 5/50; G06T 7/70; G06V 10/761; H04N 13/279; G06T 2207/20221

(57) ABSTRACT

The present technology relates to an image processing device, an image processing method, and a program that enable work using a predetermined machine to be performed easily and safely. An image acquirer acquires a plurality of captured images acquired by a plurality of imaging devices installed in a construction machine. A distance acquirer acquires distance information indicating a distance from a distance measurement device that measures a distance between the distance measurement device and an object imaged by the imaging devices. A display controller controls display of a 3D model image so as to display action point information indicating an action point of a 3D model of the construction machine on a 3D space on the 3D model image that is an image captured when the 3D space including the object and the 3D model of at least a part of the construction machine is imaged from a virtual viewpoint, the 3D model image being generated by using the plurality of captured images and the distance information. The present technology can be applied to, for example, a work support device or the like that supports construction work.

### TECHNICAL FIELD

The present technology relates to an image processing device, an image processing method, and a program, and especially relates to an image processing device, an image processing method, and a program that enable work using a predetermined machine to be performed easily and safely.

### BACKGROUND ART

In recent years, a system that supports work of a construction machine such as a forklift has been devised. For example, there is a forklift teleoperation system in which a plurality of cameras is mounted on the forklift, the system supporting alignment of the forklift by displaying an image of a virtual camera position generated from images of the plurality of cameras and a guideline (see, for example, Patent Document 1). The forklift teleoperation system sets the virtual camera position to, for example, a position where a shield does not shield a pallet and a fork to display the pallet, the fork, and the like in an easily viewable manner.

In addition, a see-through system for teleoperating an arm construction machine has been devised (see, for example, Non-Patent Document 1). As for a blind spot shielded by an arm, the see-through system displays, in real time at 10 fps, an image that allows visual recognition of the blind spot through the arm. The see-through system coordinate-transforms an image of a sub camera into a viewpoint of a main camera by using a three-dimensional information acquired by a laser ranging sensor, and synthesizes the image of the sub camera after the coordinate transformation with the image of the main camera to generate a display image.

### CITATION LIST

### Patent Document

Patent Document 1: Japanese Patent Application Laid-Open No. 2020-007058
Non-Patent Document 1: Tatsuki Nagano, Hiromitsu Fujii, Tatsuya Kittaka, Masataka Fuchida, Yutaro Fukase, Shigeru Aoki, Tomohiro Narumi, Atsushi Yamashita, Hajime Asama, See-through System for Teleoperation of Construction Machines with Arm, Department of Precision Engineering, Graduate School of Engineering, The University of Tokyo, Asama Lab, [searched on Mar. 29, 2021], Internet. <URL:http://www.robot.t.u-tokyo.ac.jp/asamalab/research/files/Poster2019/nagano2019.pdf>

### SUMMARY OF THE INVENTION

### Problems to be Solved by the Invention

However, it has been difficult to know a positional relationship between an action point of a machine such as a construction machine and a surrounding object from a displayed image, and it has been difficult to perform work easily or safely.

The present technology has been developed in view of such circumstances, and enables work using a predetermined machine to be performed easily and safely.

### Solutions to Problems

An image processing device or a program according to an aspect of the present technology is an image processing device including or a program that causes a computer to function as an image processing device including an image acquirer that acquires a plurality of captured images acquired by a plurality of imaging devices installed in a predetermined machine, a distance acquirer that acquires distance information indicating a distance from a distance measurement device that measures a distance between the distance measurement device and an object imaged by the imaging devices, and a display controller that controls display of a 3D model image that is an image captured when a 3D space including the object and a 3D model of at least a part of the predetermined machine is imaged from a virtual viewpoint, so as to display action point information indicating an action point of the 3D model of the predetermined machine on the 3D space, the 3D model image being generated by using the plurality of captured images acquired by the image acquirer and the distance information acquired by the distance acquirer.

An image processing method according to an aspect of the present technology is an image processing method including by an image processing device, acquiring a plurality of captured images acquired by a plurality of imaging devices installed in a predetermined machine, acquiring distance information indicating a distance from a distance measurement device that measures a distance between the distance measurement device and an object imaged by the imaging devices, and controlling display of a 3D model image that is an image captured when a 3D space including the object and a 3D model of at least a part of the predetermined machine is imaged from a virtual viewpoint, so as to display action point information indicating an action point of the 3D model of the predetermined machine on the 3D space, the 3D model image being generated by using the plurality of captured images and the distance information.

In an aspect of the present technology, a plurality of captured images acquired by a plurality of imaging devices installed in a predetermined machine is acquired, distance information indicating a distance from a distance measurement device that measures a distance between the distance measurement device and an object imaged by the imaging devices is acquired, and display of a 3D model image that is an image captured when a 3D space including the object and a 3D model of at least a part of the predetermined machine is imaged from a virtual viewpoint is controlled so as to display action point information indicating an action point of the 3D model of the predetermined machine on the 3D space, the 3D model image being generated by using the plurality of captured images and the distance information.

### BRIEF DESCRIPTION OF DRAWINGS

FIG. 1 is a block diagram illustrating a configuration example of a first embodiment of a construction work system to which the present technology is applied.

FIG. 2 is a perspective view illustrating an external configuration example of a construction machine system in FIG. 1.

FIG. 3 is a block diagram illustrating a configuration example of a work support device.

FIG. 4 is a diagram illustrating a configuration example of an object table.

FIG. 5 is a diagram illustrating an example of a work support screen.

FIG. 6 is a flowchart describing display control processing.

FIG. 7 is a flowchart describing the display control processing.

FIG. 8 is a perspective view illustrating an external configuration example of a construction machine system according to a second embodiment of the construction work system to which the present technology is applied.

FIG. 9 is a diagram illustrating an example of the work support screen displayed on the construction machine system in FIG. 8.

FIG. 10 is a perspective view illustrating an external configuration example of the construction machine system in FIG. 8 in a case where an operator is present near the construction machine system.

FIG. 11 is a diagram illustrating an example of the work support screen displayed on the construction machine system in FIG. 10.

FIG. 12 is a block diagram illustrating a configuration example of hardware of a computer.

### MODE FOR CARRYING OUT THE INVENTION

Hereinafter, modes for carrying out the present technology (hereinafter, referred to as embodiments) will be described. Note that the description will be given in the following order.
1. First embodiment (construction work system in which attachment is grapple)
2. Second embodiment (construction work system in which attachment is breaker)
3. Computer

### First Embodiment

### <Configuration Example of Construction Work System>

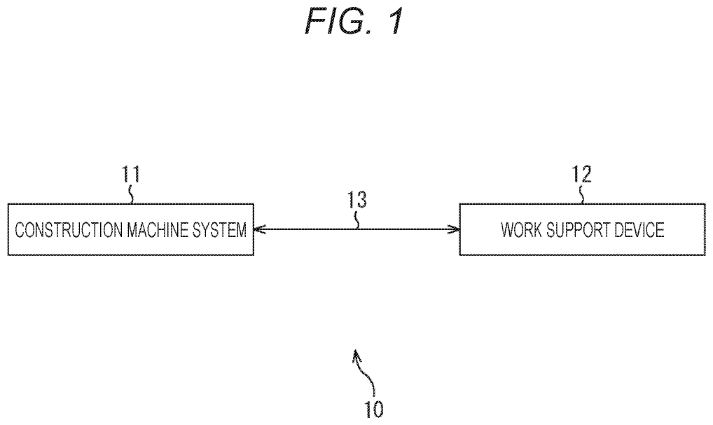

FIG. 1 is a block diagram illustrating a configuration example of a first embodiment of a construction work system to which the present technology is applied.

A construction work system 10 in FIG. 1 is configured by connecting a construction machine system 11 and a work support device 12 via a wired or wireless network 13. The construction machine system 11 performs construction work under the control of the work support device 12. The work support device 12 is an image processing device that displays a work support screen that supports construction work on the basis of a captured image and the like transmitted from the construction machine system 11. The user inputs a desired operation to the work support device 12 while viewing the work support screen, and thus, performs a remote operation of the construction machine system 11 and performs construction work using the construction machine system 11.

### <External Configuration Example of Construction Machine System>

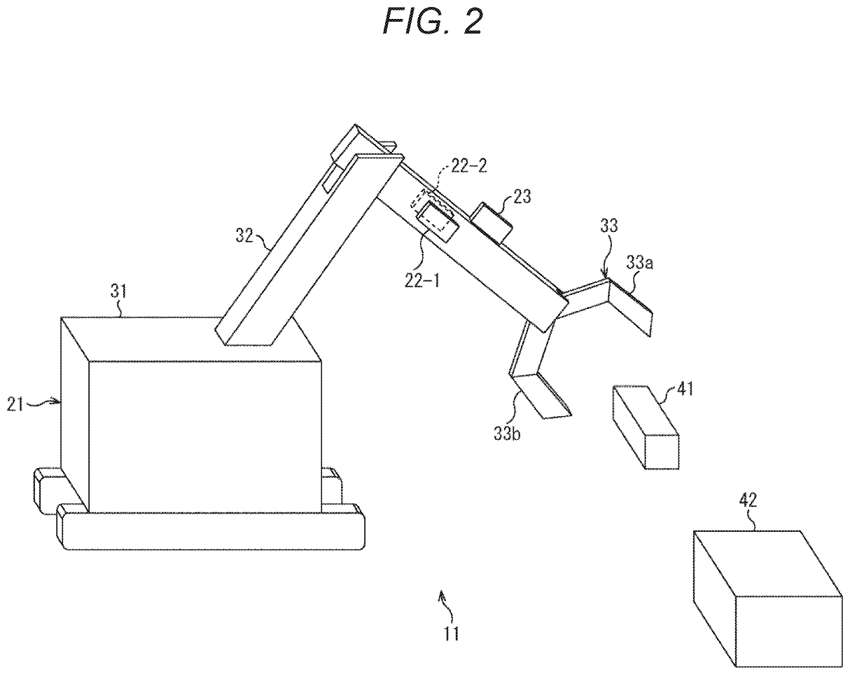

FIG. 2 is a perspective view illustrating an external configuration example of the construction machine system 11 in FIG. 1.

As illustrated in FIG. 2, the construction machine system 11 includes a construction machine 21, two imaging devices 22-1 and 22-2, and a distance measurement device 23.

The construction machine 21 includes a body 31, an arm 32, and a grapple 33. The body 31 is configured to be movable on an installation surface such as a ground, and the arm 32 is installed on an upper surface of the body 31. The arm 32 is movable or rotatable up and down, and various attachments can be attached to a distal end portion of the arm 32. The grapple 33 has grippers 33a and 33b, and is attached to the arm 32 as an attachment.

In the construction machine 21 configured as described above, the body 31 moves on the installation surface so as to approach a work target, and the arm 32 moves or rotates up and down so that the grapple 33 moves to a position where the work target can be gripped. The grippers 33a and 33b of the grapple 33 grip the work target, and then, the arm 32 moves or rotates up and down as necessary, and the body 31 moves to a predetermined position on the installation surface. Then, the arm 32 moves or rotates up and down as necessary, and the grapple 33 releases the work target at a predetermined timing. As described above, the construction machine 21 performs work of gripping and moving the work target to a predetermined position as construction work.

The imaging devices 22-1 and 22-2 are installed at symmetrical positions on a side surface of the arm 32 of the construction machine 21. Note that, in FIG. 2, the imaging device 22-2 is illustrated in a transparent manner for convenience of description. Furthermore, in the following description, in a case where it is not necessary to distinguish the imaging devices 22-1 and 22-2, the imaging devices are collectively referred to as an imaging device 22. The imaging device 22 captures images in units of frames, for example, and transmits the captured images obtained as a result to the work support device 12 via the network 13.

The distance measurement device 23 is, for example, a laser distance sensor, and is installed on the arm 32 near the imaging device 22. The distance measurement device 23 emits a laser in substantially the same direction as an imaging direction of the imaging device 22, and receives light reflected from an object existing within an emission range. Here, the emission range includes the imaging range of the imaging device 22. Therefore, the distance measurement device 23 receives light reflected from each object imaged by the imaging device 22. The distance measurement device 23 measures a distance between the object and the distance measurement device 23 at each point (for example, a point corresponding to each pixel of the captured image) arranged in a matrix within the emission range on the basis of the received light, and transmits distance information indicating the distance to the work support device 12 via the network 13.

In the example in FIG. 2, pipe-shaped material 41 is provided as a work target of the construction machine system 11 at a position separated from the grapple 33 by a predetermined distance within the imaging range of each imaging device 22. In addition, another construction machine 42 is located at a position within the imaging range of each imaging device 22 away from the material 41 toward a front side in FIG. 2 by a predetermined distance.

In this case, the imaging devices 22-1 and 22-2 capture an image in substantially the same imaging direction from an installation position, and acquire a captured image including objects such as the grapple 33, the material 41, and the another construction machine 42 as subjects. Then, the imaging device 22 transmits the captured image to the work support device 12 via the network 13.

In addition, the distance measurement device 23 emits a laser in substantially the same direction as the imaging direction of the imaging device 22, and receives light reflected from the objects such as the grapple 33, the material 41, and the another construction machine 42 imaged by the imaging device 22. Then, the distance measurement device 23 measures the distance between the distance measurement device 23 and an object such as the grapple 33, the material 41, or the another construction machine 42 at each point in the emission range on the basis of the received light, and transmits distance information indicating the distance to the work support device 12 via the network 13.

### <Configuration Example of Work Support Device 12>

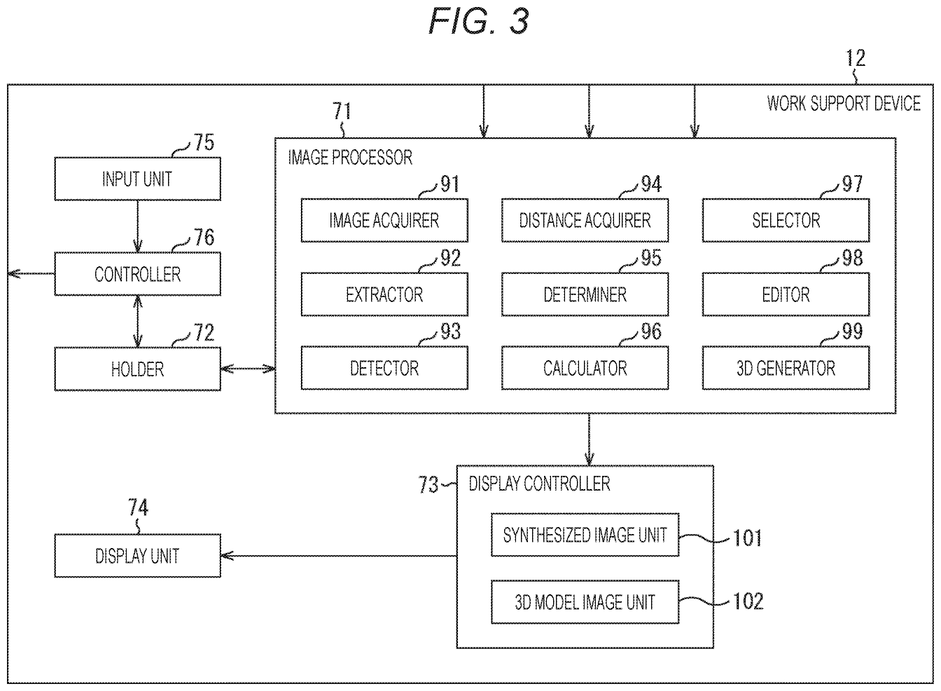

FIG. 3 is a block diagram illustrating a configuration example of the work support device 12 in FIG. 1.

The work support device 12 in FIG. 3 includes an image processor 71, a holder 72, a display controller 73, a display unit 74, an input unit 75, and a controller 76.

The image processor 71 includes an image acquirer 91, an extractor 92, a detector 93, a distance acquirer 94, a determiner 95, a calculator 96, a selector 97, an editor 98, and a 3D generator 99.

The image acquirer 91 acquires the captured image transmitted from the imaging device 22 in FIG. 2 via the network 13, and supplies the captured image to the extractor 92 and the 3D generator 99.

The extractor 92 extracts feature points from each of the two captured images supplied from the image acquirer 91 in accordance with a predetermined feature amount detection method such as oriented FAST and rotated BRIEF (ORB). The extractor 92 supplies feature point information indicating the feature amount and the position of each extracted feature point to the determiner 95.

Furthermore, the extractor 92 performs matching of feature points in each captured image, and calculates a projective transformation matrix between the two captured images on the basis of the positions of the matched feature points on each captured image. The extractor 92 generates a captured image of a predetermined viewpoint from each of the two captured images by using the calculated projective transformation matrix. As this viewpoint, an arbitrary viewpoint can be set, and for example, the viewpoint is set to a center of the imaging device 22-1 and the imaging device 22-2, or set to any one of the imaging device 22-1 or the imaging device 22-2. The extractor 92 supplies captured images of two predetermined viewpoints to the detector 93.

By using the captured images of the two predetermined viewpoints supplied from the extractor 92, the detector 93 detects, as a shielded region, a region where a plurality of objects having different positions in a depth direction in the captured images overlaps, for example, a region shielded by a shield such as the arm 32 or the grapple 33. The extractor 92 supplies information indicating the detected shielded region and the captured images of the two predetermined viewpoints to the editor 98.

The distance acquirer 94 acquires distance information transmitted from the distance measurement device 23 in FIG. 2 via the network 13, and supplies the distance information to the calculator 96.

The determiner 95 determines a type of the object included in the captured image on the basis of the feature point information supplied from the extractor 92 and expected object information held in the holder 72.

Specifically, the expected object information is obtained by associating an object ID that is a unique ID assigned to an expected object with object information of the object. The object information includes, for example, the type of the object, an initial value of a 3D model, a size of a height, a width, and a depth, an appropriate distance range, and the feature amount of the feature point indicating the object in the captured image when the object is captured from various directions.

Examples of the type of the object include a type of an object that is not desired to be harmed during construction work, such as a “person”, “something unknown”, a “building not to destroy”, and “another construction machine”, a “work target” indicating that the object is an object registered as a current work target, a “non-work target” indicating that the object is a work target candidate that is not registered as a current work target, and a “non-detection target” indicating that the object is an object that is known in position, size, and the like of the arm 32, the grapple 33, and the like and does not need to be detected as an object. Note that, since the feature amount of an object whose type is the “something unknown” is unknown, for example, information indicating that the feature amount is other than the feature amount corresponding to the type of another object is registered as the feature amount.

Furthermore, the appropriate distance range is a range of a distance between the object and the grapple 33 in which the construction machine system 11 is less likely to harm during the construction work. The expected object information is set on the basis of, for example, an operation or the like of the user on the input unit 75 before a start of work.

When the feature amount indicated by the feature point information is the same as or similar to the feature amount corresponding to the “person” as the type of the object in the expected object information by a face detection algorithm, the determiner 95 determines that an object whose type is the “person” is included in the captured image. Then, the determiner 95 recognizes the object ID corresponding to the feature amount same as or similar to the feature amount indicated by the feature point information as the object ID of the object included in the captured image. Here, it is assumed that the feature amount of a general person is registered as the feature amount of the object whose type is the “person”, but the type of the object may be a “specific person”, and the feature amount of the specific person may be registered as the feature amount of the object.

In addition, in a case where the feature amount indicated by the feature point information is other than the feature amount corresponding to the type of another object as indicated by information as the feature amount corresponding to, for example, the “something unknown” as the type of the object in the expected object information, that is, in a case where the feature amount same as or similar to the feature amount indicated by the feature point information does not exist in the expected object information (a case where every similarity between the feature amount indicated by the feature point information and each feature amount registered in the expected object information is less than a threshold), the determiner 95 determines that the captured image includes an object whose type is the “something unknown”. Then, the determiner 95 recognizes the object ID corresponding to the “something unknown” as the type of the object as the object ID of the object included in the captured image.

In addition, when the feature amount indicated by the feature point information is the same as or similar to the feature amount corresponding to the “building not to destroy” as the type of the object in the expected object information, the determiner 95 determines that an object whose type is the “building not to destroy” is included in the captured image. Similarly, the determiner 95 determines that the captured image includes an object whose type is the “another construction machine”, “work target”, or “non-work target”, on the basis of the feature amount indicated by the feature point information and the expected object information. Then, the determiner 95 recognizes the object ID corresponding to the feature amount same as or similar to the feature amount indicated by the feature point information as the object ID of the object included in the captured image.

When the feature amount indicated by the feature point information is the same as or similar to the feature amount corresponding to the “non-detection target” as the type of the object in the expected object information, the determiner 95 determines that an object whose type is the “non-detection target” is included in the captured image. Then, the determiner 95 does not recognize and ignores the object ID of this object.

The determiner 95 sets each object whose object ID is recognized as an object to be processed, and assigns a target object ID that is a unique ID to each object to be processed. The determiner 95 supplies a target object table in which the target object ID is associated with the feature point information and the object ID corresponding to the object to which the target object ID is assigned to the holder and causes the holder 72 to hold the target object table.

The calculator 96 reads, from the holder 72, the distance measurement device information indicating the position and orientation of the distance measurement device 23 on the arm 32, and attachment position information and grapple position information in grapple information. The attachment position information is information indicating an attachment position of the grapple 33 on the arm 32. The grapple position information is information indicating a current open/close angle and orientation of the grapple 33.

The grapple information includes, for example, an initial value of a 3D model of the grapple 33, movable range specifying information, and position information of an action point in addition to the attachment position information and the grapple position information. The movable range specifying information of the grapple 33 is information for specifying a movable range of the grapple 33 with respect to the attachment position, and is, for example, information indicating a range of the open/close angle of the grapple 33. The information indicating the range of the open/close angle of the grapple 33 is, for example, information indicating a minimum angle and a maximum angle of an angle formed by a straight line connecting the attachment position of the grapple 33 and a distal end portion of the gripper 33a or 33b and a straight line parallel to the arm 32 passing through the attachment position, which can be taken when the grapple 33 performs a motion of opening, closing, and gripping.

The action point of the grapple 33 is the distal end portions of the grippers 33a and 33b in contact with an object as the work target when the grapple 33 grips, that is, ends farthest from the attachment position to the arm 32. Position information of the action point of the grapple 33 is, for example, information indicating a relative position of the action point at each position in the movable range of the grapple 33 with respect to the attachment position to the arm 32.

The calculator 96 recognizes a current positional relationship between the distance measurement device 23 and the grapple 33 on the basis of the distance measurement device information, the attachment position information, and the grapple position information.

The calculator 96 reads, for every target object ID, the feature point information corresponding to the target object ID from the target object table held in the holder 72. The calculator 96 extracts, for every target object ID, distance information of a point corresponding to a position indicated by the feature point information from the distance information supplied from the distance acquirer 94. The calculator 96 calculates a distance between the grapple 33 and the object to be processed for every target object ID on the basis of the extracted distance information, the current positional relationship between the distance measurement device 23 and the grapple 33, and the orientation of the distance measurement device 23 indicated by the distance measurement device information. For every target object ID, the calculator 96 supplies object distance information indicating the distance to the holder 72, and registers the object distance information in the target object table held in the holder 72.

The selector 97 reads the object ID and the object distance information of the object to be processed, the object being registered in the target object table held in the holder 72. In addition, the selector 97 reads the type of the object and the appropriate distance range in the object information corresponding to the object ID from the holder 72. The selector 97 selects the object to be processed as an object of interest to which attention is paid in the work support screen on the basis of the read type, appropriate distance range, and object distance information of the object to be processed.

Specifically, the selector 97 preferentially selects an object to be processed that is not desired to harm during construction work as the object of interest. More specifically, the selector 97 determines for every object to be processed whether or not the distance indicated by the object distance information of the object is a distance outside the appropriate distance range. Then, the selector 97 sets an object to be processed at a distance outside the appropriate distance range as a candidate for the object of interest.

Then, the selector 97 preferentially selects one candidate of the object of interest as the object of interest in the order of types of the object of “person”, “something unknown”, “building not to destroy”, “another construction machine”, “work target”, and “non-work target”. Here, the order of the “person”, “something unknown”, “building not to destroy”, and “another construction machine” is the order of the types of object that is not desired to harm during construction work. In addition, the order of the “work target” and the “non-work target” is the order of the types of object to which more attention is to be paid during the construction work. The selector 97 supplies the target object ID of the object of interest to the editor 98, and supplies the target object ID and the object ID to the 3D generator 99.

The editor 98 synthesizes the captured images of the two predetermined viewpoints supplied from the detector 93 to generate a synthesized image of the predetermined viewpoints. At this time, the editor 98 edits and synthesizes the shielded regions of the captured images of the two predetermined viewpoints by alpha blending on the basis of the information indicating the shielded region supplied from the detector 93. As a result, in the shielded region, the image of the object on a deeper side than the viewpoint is made translucent, and a synthesized image in which the shield is made transparent is generated.

In addition, the editor 98 reads the feature point information corresponding to the target object ID from the target object table held in the holder 72 on the basis of the target object ID of the object of interest supplied from the selector 97. On the basis of the feature point information, the editor 98 performs filter processing of highlighting the object of interest with shading, translucent filling, or the like on the synthesized image. The editor 98 supplies the synthesized image subjected to the filter processing to the display controller 73.

The 3D generator 99 reads the feature point information and the object distance information corresponding to the target object ID from the target object table held in the holder 72 on the basis of the target object ID of the object of interest supplied from the selector 97.

In addition, the 3D generator 99 reads, from the holder 72, the object information corresponding to the object ID of the object of interest supplied from the selector 97. Furthermore, the 3D generator 99 reads imaging position information, the attachment position information, and the grapple position information from the holder 72. The imaging position information includes, for example, information indicating a position and orientation of the imaging device 22 on the arm 32.

The 3D generator 99 arranges a model of the object of interest, which is a 3D model corresponding to the object of interest, on a 3D space on the basis of the two captured images supplied from the image acquirer 91, and the feature point information, the object distance information, the object information, the imaging position information, the attachment position information, and the grapple position information of the object of interest.

Specifically, the 3D generator 99 determines the position of the model of the object of interest on the 3D space on the basis of the position indicated by the feature point information of the object of interest, the object distance information, the imaging position information, the attachment position information, and the grapple position information. Note that the origin of the 3D space is, for example, either the imaging device 22-1 or the imaging device 22-2, or the center of the positions of the imaging device 22-1 and the imaging device 22-2. That is, the position the model of the object of interest is determined by a relative position with the origin corresponding to the imaging device 22.

Furthermore, the 3D generator 99 calculates an orientation of the object of interest in the two captured images on the basis of the two captured images and the feature point information and the object information of the object of interest. The 3D generator 99 determines an orientation of the model of the object of interest on the 3D space on the basis of the calculated orientation. Then, the 3D generator 99 generates the model of the object of interest at the determined position on the 3D space in the determined orientation on the basis of an initial value of the 3D model of the object of interest.

Note that, in a case where the orientation of the object of interest cannot be detected, the 3D generator 99 determines the orientation of the model of the object of interest to be a predetermined orientation set in advance. In this case, a notification indicating that the orientation of the object of interest cannot be detected may be provided on the work support screen.

The 3D generator 99 also reads arm information held in the holder 72. The arm information includes, for example, an initial value of a 3D model of the arm 32 and a length of the arm 32. The 3D generator 99 generates an arm model, which is a 3D model corresponding to the arm 32, on the 3D space in which the model of the object of interest is disposed on the basis of the arm information and the imaging position information.

Furthermore, the 3D generator 99 reads the initial value of the 3D model of the grapple 33 held in the holder 72. On the basis of the attachment position information, the grapple position information, and the initial value of the 3D model of the grapple 33, the 3D generator 99 generates a grapple model, which is a 3D model corresponding to the grapple 33, on the 3D space in which the model of the object of interest and the arm model are disposed. As a result, the grapple model is disposed on the 3D space corresponding to the current open/close angle and orientation of the grapple 33.

Furthermore, the 3D generator 99 reads the movable range specifying information held in the holder 72. On the basis of the movable range specifying information, the 3D generator 99 moves the grapple model in an alpha blend state and draws the grapple model on the 3D space to express the movable range. That is, the 3D generator 99 draws the grapple model in a translucent manner in a case where the grapple model exists at each position in the movable range different from a current position in the 3D space as movable range information indicating the movable range of the grapple model on the 3D space.

Furthermore, the 3D generator 99 reads the position information of the action point of the grapple 33 held in the holder 72. The 3D generator 99 plots the action point of the grapple model at each position in the movable range of the grapple model on the 3D space on the basis of the position information of the action point. That is, the 3D generator 99 draws a point on the 3D space as action point information indicating the action point at each position in the movable range of the grapple model on the 3D space. At this time, for example, the 3D generator 99 plots the action point at a position other than the current position of the grapple model in the alpha blend state.

The 3D generator 99 determines a position and orientation of a virtual viewpoint in the 3D space. For example, the 3D generator 99 determines a position and orientation desired by the user as the position and orientation of the virtual viewpoint in accordance with the operation of the input unit 75 by the user.

Alternatively, the 3D generator 99 determines the position and orientation of the virtual viewpoint by a predetermined method. In this case, for example, the 3D generator 99 determines the position and orientation of the virtual viewpoint so that the action points in an image captured from the virtual viewpoint are distributed. Note that, at this time, the position and orientation of the virtual viewpoint having a larger dispersion degree may be determined more preferentially.

Furthermore, the 3D generator 99 may determine the position and orientation of the virtual viewpoint so that a distance between the arm model or the grapple model and the model of the object of interest in the image captured from the virtual viewpoint becomes easy to be visually observed.

Specifically, the 3D generator 99 determines, as the position and the orientation of the virtual viewpoint, an imaging position and an imaging direction at which at least a part of the arm model and a whole of the grapple model and the model of the object of interest can be imaged when a direction passing through a center of a line segment connecting the attachment position of the grapple model and a center of the model of the object of interest and perpendicular to the line segment is defined as the imaging direction. Note that, at this time, the position and orientation of the virtual viewpoint in which the imaging direction is a direction looking down on the ground, that is, a direction perpendicular to the ground are preferentially determined.

In a case where the 3D generator 99 determines the position and orientation of the virtual viewpoint by a predetermined method as described above, the 3D generator 99 preferentially selects a position close to the position of the virtual viewpoint of a previous frame. As a result, an abrupt change in the virtual viewpoint can be prevented.

The 3D generator 99 generates a captured image when the 3D space is imaged from the virtual viewpoint as a 3D model image on the basis of the position and orientation of the virtual viewpoint, and supplies the 3D model image to the display controller 73.

The holder 72 includes a hard disk, a nonvolatile memory, and the like. The holder 72 holds the expected object information, the target object table, the distance measurement device information, the grapple information, the arm information, and the imaging position information.

The display controller 73 includes a synthesized image unit 101 and a 3D model image unit 102. The synthesized image unit 101 controls display of the synthesized image so as to display the synthesized image supplied from the editor 98 on the entire work support screen.

The 3D model image unit 102 controls display of the 3D model image so as to display the 3D model image supplied from the 3D generator 99 in a predetermined region of the work support screen. A display region of the 3D model image can be designated, for example, by the user operating the input unit 75, or can be determined by the 3D model image unit 102 by a predetermined method. Examples of a method of determining the display region of the 3D model image include, for example, a method of preferentially determining, as the display region, a region having fewer feature points in the synthesized image and close to the display region in the previous frame.

The input unit 75 includes a keyboard, a mouse, a microphone, a button, and the like. The input unit 75 receives an operation from the user and supplies a signal corresponding to the operation to the controller 76 and the like. For example, the user operates the input unit 75 to input a command for operating the construction machine system 11 while viewing the work support screen displayed on the display unit 74. The input unit 75 supplies an operation signal for operating the construction machine system 11 according to the command to the controller 76.

The controller 76 transmits a control signal for controlling the construction machine system 11 to the construction machine system 11 via the network 13 on the basis of the operation signal or the like for operating the construction machine system 11 supplied from the input unit 75.

For example, the controller 76 reads the movable range specifying information from the holder 72 in accordance with an operation signal for operating the grapple 33 supplied from the input unit 75. Then, the controller 76 transmits, to the construction machine system 11, a control signal for controlling the grapple 33 so that a motion based on the operation signal is performed within the movable range specified by the movable range specifying information. As a result, the grapple 33 performs a motion desired by the user in the movable range. At this time, the controller 76 supplies information indicating the open/close angle and the orientation of the operated grapple 33 to the holder 72 as new grapple position information, and updates the held grapple position information.

### <Configuration Example of Target Object Table>

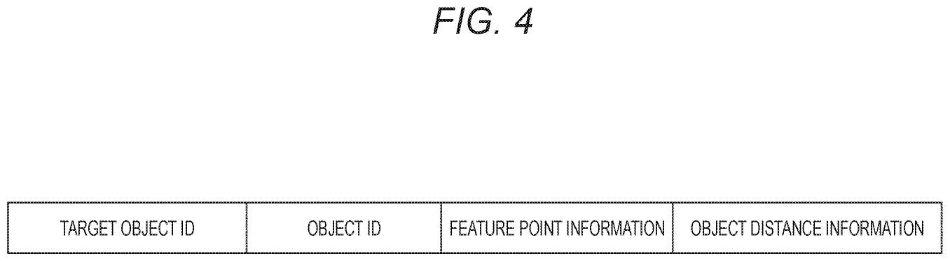

FIG. 4 is a diagram illustrating a configuration example of the target object table held in the holder 72 in FIG. 3.

As illustrated in FIG. 4, the target object IDs of all processing targets assigned by the determiner 95 are registered in the target object table. In addition, the determiner 95 registers the object ID and the feature point information in association with the target object ID. Furthermore, the calculator 96 registers the object distance information in association with the target object ID.

### <Example of Work Support Screen>

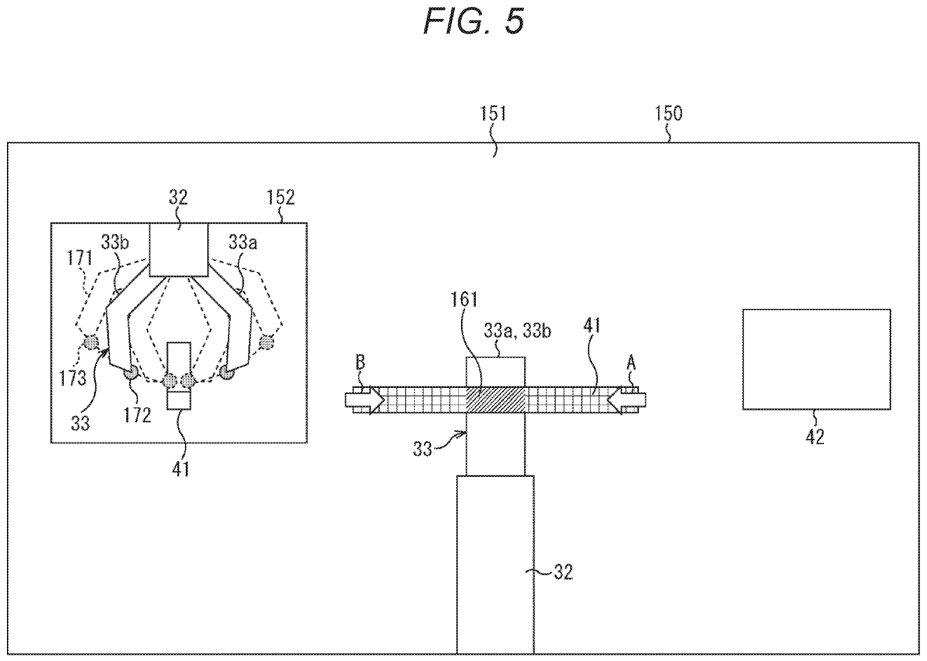

FIG. 5 is a diagram illustrating an example of the work support screen displayed on the display unit 74 in FIG. 3.

In the example of FIG. 5, the construction machine system 11, the material 41, and the another construction machine 42 are disposed as illustrated in FIG. 2. In addition, in the example of FIG. 5, the viewpoint of the synthesized image is a center of distance measurement device 23. Furthermore, a distance between the grapple 33 and the material 41 is outside the appropriate distance range corresponding to the material 41, and the distance between the grapple 33 and the another construction machine 42 is within the appropriate distance range corresponding to the other construction machine 42.

In this case, as illustrated in FIG. 5, the synthesized image 151 displayed on an entire work support screen 150 includes the arm 32, the grapple 33, and the material 41 at the center, and the another construction machine 42 on the right side. In addition, a central region 161 of the material 41, which is shielded by the grapple 33, is detected as a shielded region by the detector 93. Consequently, the material 41 on a deeper side than the grapple 33 with respect to the viewpoint in the region 161 is displayed in a translucent manner by alpha blending. That is, in the synthesized image 151, the grapple 33 is made transparent.

In addition, in a case in FIG. 5, the determiner 95 recognizes the material 41 and the another construction machine 42 in the captured image as target objects. Then, the selector 97 selects the material 41 outside the appropriate distance range from the material 41 and the another construction machine 42 as an object of interest. Therefore, the material 41 which is the object of interest is highlighted. Consequently, the region 161 of the material 41 is highlighted in a translucent manner. Note that, in FIG. 5, the highlight is represented by a lattice pattern, and the translucent highlight is represented by a diagonal line pattern.

As described above, an imaging direction of the synthesized image 151 is a direction toward the ground and a direction parallel to opening and closing surfaces of the grippers 33a and 33b of the grapple 33, that is, a direction perpendicular to a long side of the material 41 which is the object of interest. That is, the imaging direction of the synthesized image 151 is a direction parallel to a straight line connecting the attachment position of the grapple 33 and a center of the material 41. Therefore, the user can recognize a state of an entire work site by the synthesized image 151, but has a difficulty in recognizing the distance between the material 41 and the grapple 33 that needs to be looked at during work.

Therefore, the work support device 12 superimposes and displays a 3D model image 152 on a region having fewer feature points of the synthesized image 151 displayed on the work support screen 150, that is, on the left side in the example in FIG. 5. Here, in the example in FIG. 5, assuming that a direction perpendicular to a line segment passing through a center of a line segment connecting the attachment position of the grapple model to the arm model and a center of the 3D model of the material 41 is the imaging direction, the imaging position and the imaging direction at which at least a part of the arm model and the entire 3D model of the grapple model and the material 41 can be imaged are determined as the position and orientation of the virtual viewpoint.

Therefore, the orientation of the virtual viewpoint is a direction indicated by an arrow A or an arrow B in FIG. 5 perpendicular to a line segment connecting the attachment position of the grapple model and the center of the 3D model of the material 41. Accordingly, the user can recognize, from the 3D model image 152, the distance between the grapple 33 and the material 41. Consequently, for example, it is possible to immediately find that the grapple 33 and the material 41 are unintentionally so close to each other as to be in a dangerous state.

In addition, since the orientation of the virtual viewpoint indicated by the arrow A or the arrow B in FIG. 5 is a direction perpendicular to the opening and closing surfaces of the grippers 33a and 33b of the grapple 33, the user can recognize the entire movable range of the grapple 33 from the 3D model image 152.

Furthermore, in the 3D model image 152, as the movable range information, an image 171 of the grapple model in a case where the grapple model exists at each position in the movable range different from the current position is displayed in a translucent manner by alpha blending. In the example in FIG. 5, only the image 171 in a case where the grapple model exists at the most open position and the most closed position is displayed. However, an image of the grapple model in a case where the grapple model exists at another position may also be displayed. Note that, in FIG. 5, a normal display in the 3D model image 152 is represented by a solid line, and a translucent display is represented by a dotted line.

In addition, in the 3D model image 152, a point 172 is also displayed at the distal end portions of the grippers 33a and 33b as the action point information of the grapple model at the current position. Furthermore, in the 3D model image 152, a point 173 is displayed in a translucent manner by alpha blending at a distal end portion of the image 171 as the action point information indicating the action point of the grapple model in a case where the grapple model exists at each position in the movable range different from the current position.

As described above, in the 3D model image 152, the distance between the grapple 33 and the material 41 can be recognized, and the point 172 and the point 173 are displayed as the action point information of the grapple model. Therefore, the user can easily or safely perform the construction work using the grapple 33 while viewing the 3D model image 152.

### <Description of Display Control Processing>

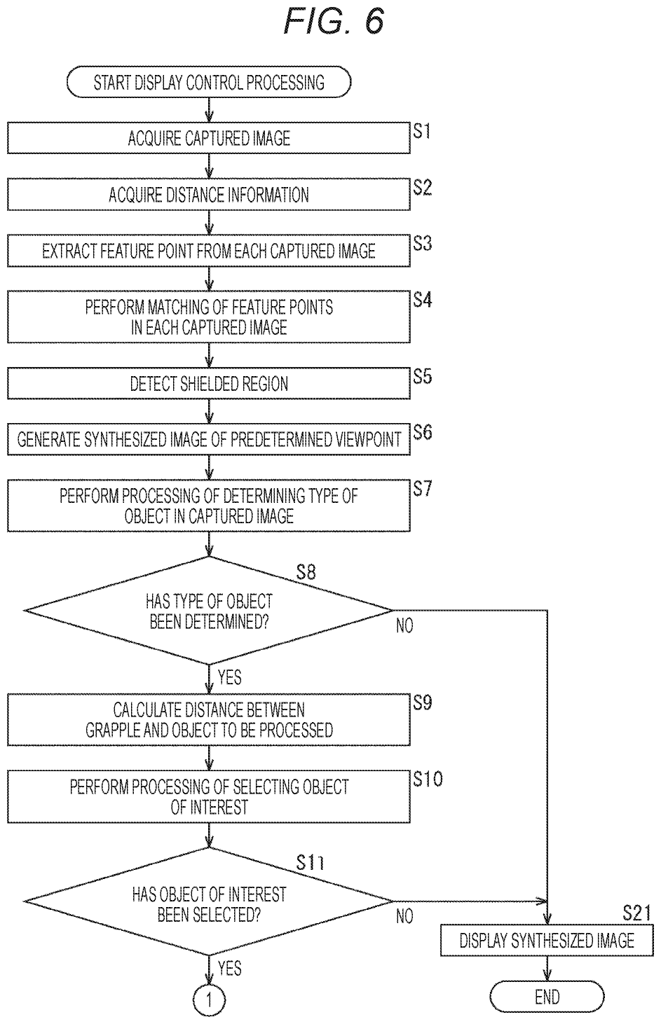

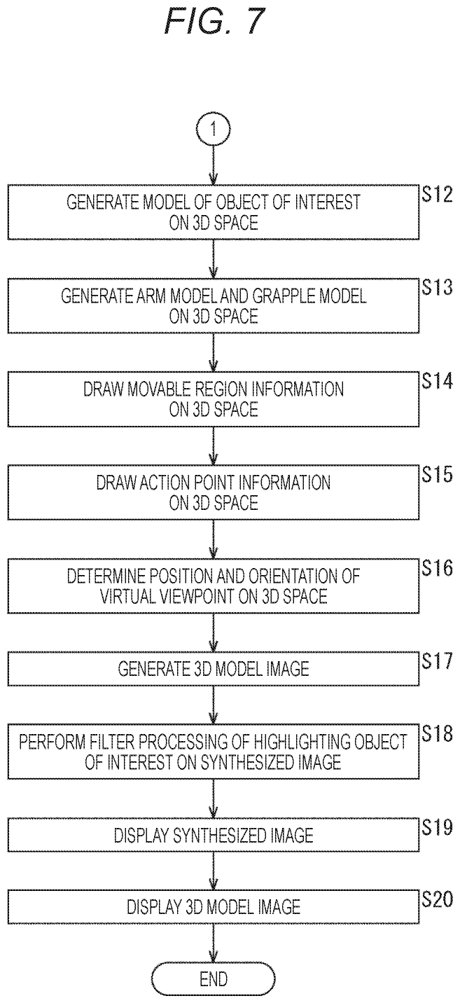

FIGS. 6 and 7 are flowcharts for describing display control processing in which the work support device 12 in FIG. 3 displays the work support screen. The display control processing is started, for example, when a captured image is input in units of frames from the imaging device 22 in FIG. 2.

In step S1 in FIG. 6, the image acquirer 91 of the work support device 12 acquires a captured image transmitted from the imaging device 22 via the network 13, and supplies the captured image to the extractor 92 and the 3D generator 99.

In step S2, the distance acquirer 94 acquires distance information transmitted from the distance measurement device 23 via the network 13, and supplies the distance information to the calculator 96.

In step S3, the extractor 92 extracts a feature point from each of the two captured images acquired in step S1 in accordance with a predetermined method of detecting a feature amount. The extractor 92 supplies the feature point information of each extracted feature point to the determiner 95.

In step S4, the extractor 92 performs matching of the feature points in each captured image extracted in step S3, and calculates a projective transformation matrix between the two captured images on the basis of the positions of the matched feature points on each captured image. The extractor 92 generates a captured image of a predetermined viewpoint from each of the two captured images by using the calculated projective transformation matrix, and supplies the captured image to the detector 93.

In step S5, the detector 93 detects a shielded region in the captured image by using the captured images of the two predetermined viewpoints generated in step S4. The detector 93 supplies information indicating the detected shielded region and the captured images of the two predetermined viewpoints to the editor 98.

In step S6, the editor 98 generates a synthesized image in which a shield is made transparent from the captured images of the two predetermined viewpoints on the basis of the information indicating the shielded region detected in step S5.

In step S7, the determiner 95 performs processing of determining a type of the object in the captured image on the basis of the feature point information supplied from the extractor 92 and expected object information held in the holder 72.

In step S8, the determiner 95 determines whether or not the type of the object has been determined in step S7, that is, whether or not the object ID has been recognized in step S7.

In a case where it is determined in step S8 that the type of the object has been determined, that is, in a case where the object ID has been recognized in step S7, the object having the object ID is set as an object to be processed, and a target object ID is assigned. Then, the determiner 95 supplies the target object table including the target object ID to the holder 72 to hold, and the processing proceeds to step S9.

In step S9, the calculator 96 calculates a distance between the grapple 33 and the object to be processed for every target object ID on the basis of the distance measurement device information, the attachment position information, the grapple position information, and the feature point information held in the holder 72 and the distance information acquired in step S2. For every target object ID, the calculator 96 supplies object distance information indicating the distance to the holder 72, and registers the object distance information in the target object table held in the holder 72.

In step S10, the selector 97 performs processing of selecting the object of interest from the object to be processed on the basis of the type of the object to be processed, the appropriate distance range, and the object distance information held in the holder 72.

In step S11, it is determined whether or not the object of interest has been selected in step S10, that is, whether or not there is an object to be processed in which the distance indicated by the object distance information is outside the appropriate distance range. In a case where it is determined in step S11 that the object of interest has been selected, that is, in a case where there is an object to be processed in which the distance indicated by the object distance information is outside the appropriate distance range, the selector 97 supplies the target object ID of the selected object of interest to the editor 98. Furthermore, the selector 97 supplies the target object ID and the object ID to the 3D generator 99. Then, the processing proceeds to step S12 in FIG. 7.

In step S12, the 3D generator 99 generates the model of the object of interest on the 3D space on the basis of the feature point information, the object distance information, the object information, the imaging position information, the attachment position information, and the grapple position information of the object of interest selected in step S10, and the two captured images acquired in step S1 in FIG. 6.

In step S13, the 3D generator 99 generates the arm model and the grapple model on the 3D space in which the model of the object of interest is generated in step S12 on the basis of the arm information, the grapple information, the imaging position information, and the attachment position information.

In step S14, the 3D generator 99 draws a translucent grapple model on the 3D space as the movable range information by moving the grapple model in the alpha blend state on the basis of the movable range specifying information.

In step S15, the 3D generator 99 draws a point on the 3D space as the action point information on the basis of the position information of the action point.

In step S16, the 3D generator 99 determines a position and orientation of a virtual viewpoint in the 3D space. In step S17, on the basis of the position and orientation of the virtual viewpoint determined in step S16, the 3D generator 99 generates, as a 3D model image, a captured image when the 3D space generated by the processing in steps S12 to S15 is captured from the virtual viewpoint. The 3D generator 99 supplies the 3D model image to the 3D model image unit 102 of the display controller 73.

In step S18, the editor 98 performs filter processing of highlighting the object of interest on the synthesized image generated in step S6 on the basis of the feature point information corresponding to the target object ID of the object of interest supplied from the selector 97. The editor 98 supplies the synthesized image subjected to the filter processing to the synthesized image unit 101.

In step S19, the synthesized image unit 101 displays the synthesized image generated in step S18 on the entire work support screen.

In step S20, the 3D model image unit 102 displays the 3D model image generated in step S17 in a predetermined region of the work support screen. Then, the processing ends.

On the other hand, in a case where it is determined in step S8 in FIG. 6 that the type of the object has not been determined, or in a case where it is determined in step S11 that the object of interest has not been selected, the editor 98 supplies the synthesized image generated in step S6 to the synthesized image unit 101. Then, the processing proceeds to step S21.

In step S21, the synthesized image unit 101 displays the synthesized image generated in step S6 on the entire work support screen, and the processing ends.

As described above, since the work support device 12 displays the action point information on the 3D model image, the user can easily or safely perform the construction work using the grapple 33.

Note that, in the first embodiment, the work support device 12 displays only the movable range information of the grapple model on the 3D model image. However, the work support device 12 may also display information indicating the movable range of the arm model.

### Second Embodiment

### <External Configuration Example of Construction Machine System>

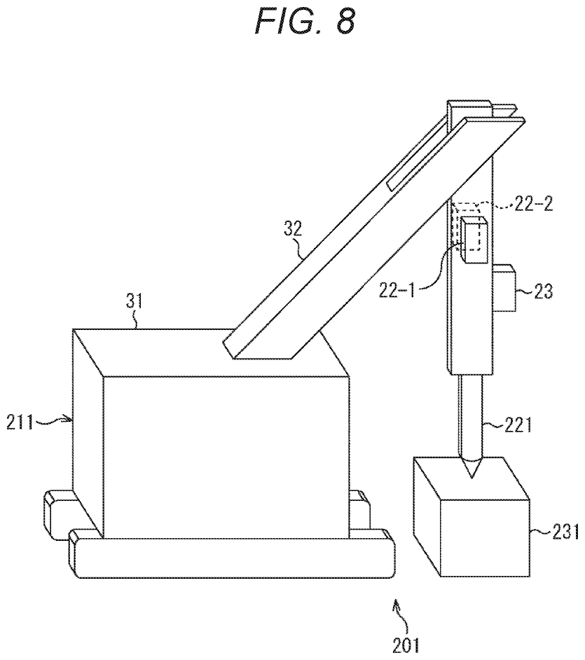

FIG. 8 is a perspective view illustrating an external configuration example of a construction machine system according to a second embodiment of the construction work system to which the present technology is applied.

The configuration of the second embodiment of the construction work system is similar to the configuration of the construction work system 10 in FIG. 1 except for the construction machine system 11. Therefore, only the construction machine system in the configuration of the second embodiment of the construction work system will be described here.

As illustrated in FIG. 8, a construction machine system 201 of the second embodiment of the construction work system is different from the construction machine system 11 in FIG. 2 in that a pile-shaped breaker 221 is provided as an attachment of the arm 32, and other configurations are similar to the configurations of the construction machine system 11.

In the construction machine system 201 in FIG. 8, portions corresponding to portions of the construction machine system 11 in FIG. 2 are denoted by the same reference signs. Therefore, description of the portions will be appropriately omitted, and description will be given focusing on portions different from portions of the construction machine system 11.

The construction machine system 201 is different from the construction machine system 11 in that a construction machine 211 is provided instead of the construction machine 21. The construction machine 211 is different from the construction machine 21 in that the breaker 221 is provided instead of the grapple 33. The breaker 221 is attached to the arm 32 as an attachment. In addition, in the example in FIG. 8, the work target is not the material 41 but a cubic stone 231. Furthermore, in the example in FIG. 8, there is not another construction machine 42.

In the construction machine 211, the body 31 moves on the installation surface so as to approach the stone 231 which is the work target, the arm 32 moves or rotates up and down, and thus, the breaker 221 moves to a position in contact with a surface of the stone 231. The breaker 221 vibrates up and down on the surface of the stone 231 to crush the stone 231. As described above, the construction machine 211 performs work of crushing the work target as construction work.

Note that the configuration of the work support device 12 in the second embodiment is similar to the configuration of the work support device 12 in FIG. 3 except that the grapple 33 is replaced with the breaker 221, and thus the description thereof is omitted. However, the grapple position information is breaker position information indicating a current position of the breaker 221 in a driving direction. In addition, a movable range of the breaker 221 is, for example, a predetermined distance range in a direction in which the breaker 221 is driven. Note that the movable range of the breaker 221 may be a vibration range of the breaker 221.

In addition, an action point of the breaker 221 is an end facing a distal end portion of the breaker 221, that is, an end of the breaker 221 attached to the arm 32.

### <First Example of Work Support Screen>

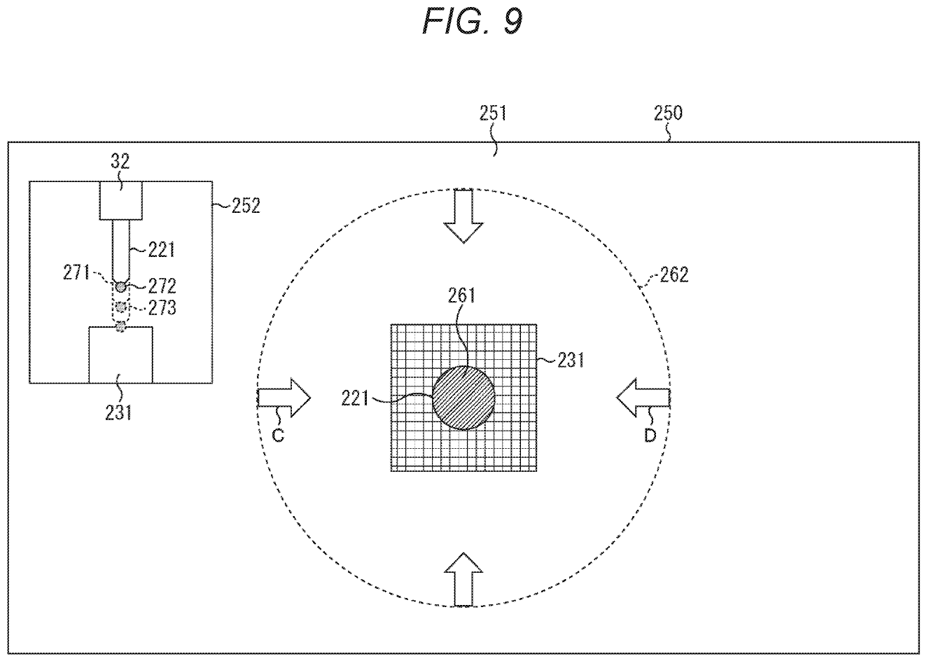

FIG. 9 is a diagram illustrating an example of a work support screen in the second embodiment of the construction work system to which the present technology is applied.

In the example in FIG. 9, the construction machine system 201 and the stone 231 are disposed as illustrated in FIG. 8. In addition, in the example in FIG. 9, the viewpoint of the synthesized image is the center of the distance measurement device 23. Furthermore, a distance between the breaker 221 and the stone 231 is outside an appropriate distance range corresponding to the stone 231.

In this case, as illustrated in FIG. 9, a synthesized image 251 displayed on an entire work support screen 250 includes the breaker 221 and the stone 231 at the center. In addition, a central region 261 of the stone 231, which is shielded by the breaker 221, is detected as a shielded region by the detector 93. Consequently, the stone 231 on a deeper side than the breaker 221 with respect to the viewpoint in the region 261 is displayed in a translucent manner by alpha blending. That is, in the synthesized image 251, the breaker 221 is made transparent.

In addition, in a case in FIG. 9, the determiner 95 recognizes the stone 231 in the captured image as a target object. Then, the selector 97 selects the stone 231 outside the appropriate distance range as an object of interest. Therefore, the stone 231 which is the object of interest is highlighted. Consequently, the region 261 of the stone 231 is highlighted in a translucent manner. Note that, in FIG. 9, the highlight is represented by a lattice pattern, and the translucent highlight is represented by a diagonal line pattern similarly to the case in FIG. 5.

As described above, an imaging direction of the synthesized image 251 is a direction toward the ground and a direction parallel to the driving direction of the breaker 221, that is, a direction perpendicular to a face of the stone 231 which is the object of interest. Therefore, the user can recognize a state of an entire work site by the synthesized image 251, but has a difficulty in recognizing the distance between the stone 231 and the breaker 221 that needs to be looked at during work.

Therefore, the work support device 12 superimposes and displays a 3D model image 252 on a region having fewer feature points of the synthesized image 251 displayed on the work support screen 250, that is, on the left side in the example in FIG. 9. Here, in the example in FIG. 9, assuming that a direction perpendicular to a line segment passing through a center of a line segment connecting the attachment position of the 3D model of the breaker 221 to the arm model and a center of the 3D model of the stone 231 is the imaging direction, the imaging position and the imaging direction at which at least a part of the arm model and the entire 3D models of the breaker 221 and the stone 231 can be imaged are determined as the position and orientation of the virtual viewpoint.

Therefore, the orientation of the virtual viewpoint is a direction perpendicular to a straight line in a driving direction of the 3D model of the breaker 221 and toward the center of the line segment connecting the attachment position of the 3D model of the breaker 221 and the center of the 3D model of the stone 231. In addition, a distance from a midpoint of the line segment to the virtual viewpoint is a distance at which at least a part of the arm model and the entire 3D models of the breaker 221 and the stone 231 can be imaged when imaged from the virtual viewpoint. Furthermore, a breaker model which is a 3D model of the breaker 221 is point-symmetric with the driving direction, and the 3D model of the stone 231 is a cube.

As described above, the position of the virtual viewpoint is a position on the circumference of a circle 262 centered on a center of a pile-shaped breaker model. In addition, the orientation of the virtual viewpoint is a direction from the virtual viewpoint toward the center of the line segment connecting the attachment position of the 3D model of the breaker 221 and the center of the 3D model of the stone 231. Note that, in FIG. 9, the orientation of the virtual viewpoint when each of the upper, lower, left, and right positions on the circumference of the circle 262 is taken as a virtual viewpoint is represented by an arrow. An arbitrary position on the circumference of the circle 262 can be set as the position of the virtual viewpoint, but in the example in FIG. 9, a position closest to the position of the imaging device 22 on the 3D space is set as the position of the virtual viewpoint. Therefore, the orientation of the virtual viewpoint is a direction indicated by an arrow C or an arrow D in FIG. 9.

As described above, the orientation of the virtual viewpoint is a direction perpendicular to the straight line in the driving direction of the 3D model of the breaker 221. Accordingly, the user can recognize, from the 3D model image 252, the distance between the breaker 221 and the stone 231. In addition, the user can recognize, from the 3D model image 252, the entire movable range which is a predetermined distance range in the driving direction of the breaker 221.

Furthermore, in the 3D model image 252, as the movable range information, an image 271 of the 3D model of the breaker 221 in a case where the 3D model of the breaker exists at each position in the movable range different from the current position is displayed in a translucent manner by alpha blending. In the example in FIG. 9, only the image 271 in a case where the 3D model of the breaker 221 exists at a central position and a lowermost position in the movable range is displayed. However, an image of the 3D model of the breaker 221 in a case where the 3D model of the breaker 221 exists at another position may be displayed. Note that, in FIG. 9, a normal display in the 3D model image 252 is represented by a solid line, and a translucent display is represented by a dotted line.

In addition, in the 3D model image 252, a point 272 is also displayed at the distal end portion of the 3D model of the breaker 221 as action point information of the 3D model of the breaker 221 at the current position. Furthermore, in the 3D model image 252, a point 273 is displayed in a translucent manner by alpha blending at a distal end portion of the image 271 as the action point information indicating the action point of the 3D model of the breaker 221 in a case where the grapple model exists at each position in the movable range different from the current position.

As described above, in the 3D model image 252, the distance between the breaker 221 and the stone 231 can be recognized, and the point 272 and the point 273 are displayed as the action point information of the 3D model of the breaker 221. Therefore, the user can easily or safely perform the construction work using the breaker 221 while viewing the 3D model image 252.

### <Second Example of Work Support Screen>

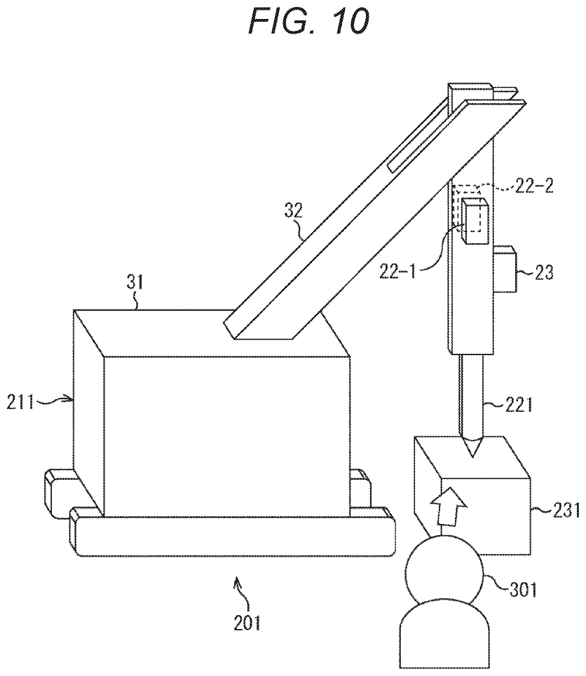

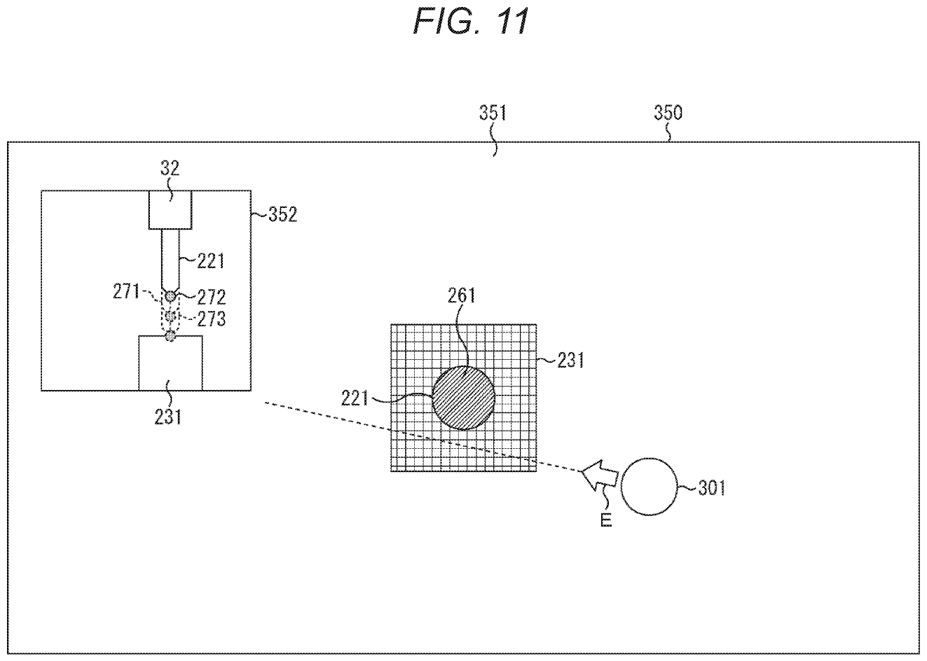

FIG. 11 is a diagram illustrating an example of the work support screen in the second embodiment of the construction work system to which the present technology is applied in a case where an operator 301 is present near the construction machine system 201 as illustrated in FIG. 10.

In FIGS. 10 and 11, portions corresponding to portions in FIGS. 8 and 9 are denoted by the same reference signs. Therefore, description of the portions will be appropriately omitted, and description will be given focusing on portions different from portions in FIGS. 8 and 9.

In the example in FIG. 10, the operator 301 stands near the construction machine system 201 and performs work while viewing in a direction of an arrow in FIG. 10 slightly shifted from the breaker 221. In this case, the position and orientation of the virtual viewpoint are determined to be, for example, the position and orientation of a line-of-sight of the operator 301.

Specifically, in this case, the imaging device 22 captures an image including the operator 301. The determiner 95 determines that the captured image includes a person object which is an object whose type is the “person”. In a case where the selector 97 does not select the person object as the object of interest, the 3D generator 99 determines the position and orientation on the 3D space corresponding to the position and orientation on a real space of the person object, similarly to the model of the object of interest. Then, the 3D generator 99 determines the position and orientation on the 3D space as the position and orientation of the virtual viewpoint.

As a result, a work support screen 350 illustrated in FIG. 11 is displayed instead of the work support screen 250 in FIG. 9. The work support screen 350 is different from the work support screen 250 in that a synthesized image 351 and a 3D model image 352 are displayed instead of the synthesized image 251 and the 3D model image 252. The synthesized image 351 is different from the synthesized image 251 in FIG. 9 in that the operator 301 is included, and other configurations are similar to those in the synthesized image 251. Furthermore, since the orientation of the virtual viewpoint is a direction indicated by an arrow E in FIG. 11 in the 3D model image 352, the arm 32, the breaker 221, the stone 231, and the like are disposed on the right side instead of the center of the image.

As described above, in a case where a person object is included in the captured image and the person object is not selected as the object of interest, in the work support device 12, the position and orientation on the 3D space corresponding to the position and orientation on the real space of the person object are determined as the position and orientation of the virtual viewpoint.

As a result, the operator 301 can perform the construction work by operating the input unit 75 while viewing the 3D model image 352 from the same viewpoint as the operator's own viewpoint, and thus, can perform the construction work easily or safely. In addition, even in a case where a person different from the operator 301 gives an instruction or a warning regarding work to the operator 301 while viewing the work support screen 350, the person can give the instruction or warning of a direction or the like from the same viewpoint as the operator 301. Consequently, it is possible to prevent an error in transmission of the instruction or warning regarding the work.

Note that the position and orientation of the person object on the real space may be detected by using a marker attached to clothing such as a helmet or work clothes of the operator 301. In this case, for example, the holder 72 holds marker information including information indicating the position of the marker on the person object, information regarding the captured image of the marker, and the like. Then, the position and orientation of the person object on the real space are detected with high accuracy on the basis of the marker information and the marker in the captured image.

In addition, in a case where an orientation of the operator 301 cannot be detected, a direction from the position of the operator 301 on the 3D space toward the breaker model can be set as the orientation of the virtual viewpoint. In this case, the operator 301 can easily grasp a positional relationship between the operator 301 and the breaker 221, and for example, can immediately determine that a danger due to an approach of the breaker 221 is imminent.

In the above description, the synthesized image 151 (251, 351) and the 3D model image 152 (252, 352) are displayed on the same work support screen 150 (250, 350), but may be displayed on different screens. In addition, the work support device 12 may include a plurality of display units, and the synthesized image 151 (251, 351) and the 3D model image 152 (252, 352) may be displayed on different display units.

Although one object is selected as the object of interest, a plurality of objects may be selected. In this case, a plurality of 3D model images may be displayed on the work support screen, or the user may select a 3D model image to be displayed on the work support screen.

Furthermore, although the determiner 95 determines the type of the object by matching the feature amounts, the determiner 95 may determine the type of the object by using a specific marker.

The input unit 75, the controller 76, and the display unit 74 may be provided as devices different from the work support device 12, or may be provided on the construction machine system 11 (201). In addition, the holder 72 may be provided outside the work support device 12, and various types of information held in the holder 72 may be read and written via a wired or wireless network. The work support device 12 may be installed on the construction machine system 11 (201).

There may be two or more imaging devices 22. Furthermore, the imaging devices 22-1 and 22-2 are not required to be provided symmetrically with the arm 32. In a case where the imaging device 22 is installed symmetrically with the arm 32, the extractor 92 can easily calculate the projective transformation matrix.

Even in a case where there is only one object to be processed, the selector 97 selects the object as the object of interest only in a case where the object is outside the appropriate distance range from the grapple 33 (the breaker 221), similarly to a case where there is a plurality of objects to be processed. However, in a case where there is only one object to be processed, the selector may select the object as the object of interest as it is, not on the basis of the appropriate distance range.

The work support screen 150 (250, 350) may include an operation screen for the user to operate the construction machine system 11 (201). In this case, the user inputs an instruction to the operation screen by using the input unit 75 while viewing the work support screen 150 (250, 350), and performs an operation on the construction machine system 11 (201).

Examples of the attachment of the arm 32, in addition to the grapple 33 and the breaker 221, include attachments that perform an opening/closing operation or a rotating operation, such as, for example, a crusher and a bucket, and attachments that are linearly driven, such as an earth auger. The movable range specifying information and the action point of the attachment are different for every type of attachment.

For example, movable range specifying information of the crusher is information indicating a range of an open/close angle of the crusher. The information indicating the range of the open/close angle of the crusher is, for example, information indicating a minimum angle and a maximum angle of an angle formed by a straight line connecting the attachment position of the crusher and a distal end portion of any one of two toothed grippers of the crusher and a straight line parallel to the arm 32 passing through the attachment position, which can be taken when the crusher performs the operation of opening/closing and gripping. In addition, an action point of the crusher is a distal end of a tooth of the toothed gripper.

A movable range specifying information of the bucket is, for example, information indicating a range of a rotation angle of the bucket. The information indicating the range of the rotation angle of the bucket is, for example, information indicating a minimum angle and a maximum angle of an angle formed by a straight line connecting the attachment position of the arm 32 and a distal end portion of the bucket and a straight line parallel to the arm 32 passing through the attachment position, which can be taken when the bucket rotates and performs a motion of scooping. In addition, in a case where the bucket has a claw at the distal end portion, an action point of the bucket is a distal end of the claw, and in a case where the bucket does not have a claw, the action points are points disposed at equal intervals at the distal end portion of the bucket.

In a case where the attachment is an earth auger, since an operation of the earth auger is a rotation operation with respect to an axial direction of the earth auger, that is, a driving direction, the movable range specifying information is not required to be registered. In this case, nothing is not required to be displayed as the movable range information, or information indicating a rotation axis of a 3D model of the earth auger or the like may be displayed. Furthermore, an action point of the earth auger is a distal end of a pile-shaped portion of the earth auger.

### <Hardware Configuration Example of Computer>

The above-described series of processing of the work support device 12 can be executed by hardware or software. In a case where the series of processing is executed by software, a program constituting the software is installed in a computer. Here, examples of the computer include a computer incorporated in dedicated hardware, and a general-purpose personal computer capable of executing various functions by installing various programs.

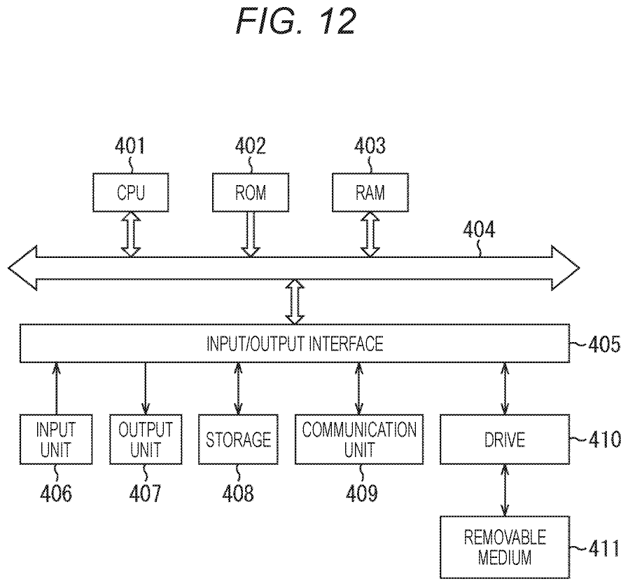

FIG. 12 is a block diagram illustrating a configuration example of the hardware of the computer that executes the above-described series of processing of the work support device 12 by the program.

In the computer, a central processing unit (CPU) 401, a read only memory (ROM) 402, and a random access memory (RAM) 403 are mutually connected by a bus 404.

An input/output interface 405 is further connected to the bus 404. An input unit 406, an output unit 407, a storage 408, a communication unit 409, and a drive 410 are connected to the input/output interface 405.

The input unit 406 includes a keyboard, a mouse, a microphone, and the like. The output unit 407 includes a display, a speaker, and the like. The storage 408 includes a hard disk, a nonvolatile memory, and the like. The communication unit 409 includes a network interface and the like. The drive 410 drives a removable medium 411 such as a magnetic disk, an optical disk, a magneto-optical disk, a semiconductor memory, or the like.

In the computer configured as described above, for example, the CPU 401 loads a program stored in the storage 408 into the RAM 403 via the input/output interface 405 and the bus 404 and executes the program, so that the above-described series of processing is performed.

The program executed by the computer (CPU 401) can be provided by being recorded in the removable medium 411 as a package medium or the like, for example. Furthermore, the program can be provided via a wired or wireless transmission medium such as a local area network, the Internet, or digital satellite broadcasting.

In the computer, the program can be installed in the storage 408 via the input/output interface 405 by attaching the removable medium 411 to the drive 410. Furthermore, the program can be received by the communication unit 409 via a wired or wireless transmission medium, and installed in the storage 408. In addition, the program can be installed in the ROM 402 or the storage 408 in advance.

Note that the program executed by the computer may be a program by which processing is performed in time series in the order described herein, or may be a program by which processing is performed in parallel or at necessary timing such as when a call is made.

The present invention can be applied to a device that supports not only construction work using a construction machine but also work using various machines such as agricultural work using an agricultural machine.

Embodiments of the present technology are not limited to the above-described embodiments, and various modifications may be made without departing from the gist of the present technology.

For example, a form in which all or some of the plurality of embodiments described above are combined can be adopted.

For example, the present technology may be configured as cloud computing in which a function is shared by a plurality of devices via the network to process together.

Furthermore, each step described in the above flowchart may be executed by one device or shared and executed by a plurality of devices.

Moreover, in a case where a plurality of processing is included in one step, the plurality of processing included in the one step can be executed by one device or shared and executed by a plurality of devices.

The effects described herein are merely examples and are not limited, and there may be other effects.

Note that, the present technology can have the following configurations.

(1)

An image processing device includes
an image acquirer that acquires a plurality of captured images acquired by a plurality of imaging devices installed in a predetermined machine,
a distance acquirer that acquires distance information indicating a distance from a distance measurement device that measures a distance between the distance measurement device and an object imaged by the imaging devices, and
a display controller that controls display of a 3D model image that is an image captured when a 3D space including the object and a 3D model of at least a part of the predetermined machine is imaged from a virtual viewpoint, so as to display action point information indicating an action point of the 3D model of the predetermined machine on the 3D space, the 3D model image being generated by using the plurality of captured images acquired by the image acquirer and the distance information acquired by the distance acquirer.

(2)

In the image processing device according to (1),
the display controller is configured to display, on the 3D model image, movable range information indicating a movable range of the 3D model of the predetermined machine on the 3D space.

(3)

In the image processing device according to (2),
the display controller is configured to display, on the 3D model image, the action point information of the 3D model of the predetermined machine at each position in the movable range.

(4)

In the image processing device according to any of (1) to (3),
an orientation of the virtual viewpoint is set to a direction perpendicular to a line segment connecting the object and the 3D model of the predetermined machine.

(5)

In the image processing device according to any of (1) to (3),
the virtual viewpoint is set such that the action points are dispersed on the 3D model image.

(6)

In the image processing device according to any of (1) to (3),
a position of the virtual viewpoint includes a position on the 3D space corresponding to a position of a person in the captured images acquired by the imaging devices.

(7)

In the image processing device according to any of (1) to (3),
the virtual viewpoint is set by a user.

(8)

The image processing device according to any of (1) to (7) further includes
a selector that selects the object as an object of interest that is an object to which attention is paid, in which
the 3D model image includes an image captured when a 3D space including the object of interest selected by the selector and at least a part of the 3D model of the predetermined machine is imaged from the virtual viewpoint.

(9)

In the image processing device according to (8),
the selector selects the object of interest on the basis of a type of the object and the distance information.

(10)

In the image processing device according to any of (1) to (7),
the display controller also controls display of a synthesized image of a predetermined viewpoint generated by synthesizing the plurality of captured images.

(11)

In the image processing device according to (10),
the display controller is configured to highlight the object in the synthesized image.

(12)

In the image processing device according to (10) or (11),
a shielded region of the synthesized image is generated by synthesizing the plurality of captured images by alpha blending.

(13)

In the image processing device according to any of (1) to (12),
at least a part of the predetermined machine includes an attachment attached to an arm of the predetermined machine.

(14)

An image processing method includes
by an image processing device,
acquiring a plurality of captured images acquired by a plurality of imaging devices installed in a predetermined machine,
acquiring distance information indicating a distance from a distance measurement device that measures a distance between the distance measurement device and an object imaged by the imaging devices, and
controlling display of a 3D model image that is an image captured when a 3D space including the object and a 3D model of at least a part of the predetermined machine is imaged from a virtual viewpoint, so as to display action point information indicating an action point of the 3D model of the predetermined machine on the 3D space, the 3D model image being generated by using the plurality of captured images and the distance information.

(15)

A program causes a computer to function as
an image acquirer that acquires a plurality of captured images acquired by a plurality of imaging devices installed in a predetermined machine,
a distance acquirer that acquires distance information indicating a distance from a distance measurement device that measures a distance between the distance measurement device and an object imaged by the imaging devices, and
a display controller that controls display of a 3D model image that is an image captured when a 3D space including the object and a 3D model of at least a part of the predetermined machine is imaged from a virtual viewpoint, so as to display action point information indicating an action point of the 3D model of the predetermined machine on the 3D space, the 3D model image being generated by using the plurality of captured images acquired by the image acquirer and the distance information acquired by the distance acquirer.

### REFERENCE SIGNS LIST

12 Work support device
21 Construction machine
22-1, 22-2 Imaging device
23 Distance measurement device
32 Arm
33 Grapple
73 Display controller
91 Image acquirer
94 Distance acquirer
97 Selector
151 Synthesized image
152 3D model image
161 Region
171 Image
172, 173 Point
211 Construction machine
221 Breaker
251 Synthesized image
252 3D model image
261 Region
271 Image
272, 273 Point
301 Operator
351 Synthesized image
352 3D model image

1. An image processing device comprising:
an image acquirer that acquires a plurality of captured images acquired by a plurality of imaging devices installed in a predetermined machine;
a distance acquirer that acquires distance information indicating a distance from a distance measurement device that measures a distance between the distance measurement device and an object imaged by the imaging devices; and
a display controller that controls display of a 3D model image that is an image captured when a 3D space including the object and a 3D model of at least a part of the predetermined machine is imaged from a virtual viewpoint, so as to display action point information indicating an action point of the 3D model of the predetermined machine on the 3D space, the 3D model image being generated by using the plurality of captured images acquired by the image acquirer and the distance information acquired by the distance acquirer.

2. The image processing device according to claim 1, wherein
the display controller is configured to display, on the 3D model image, movable range information indicating a movable range of the 3D model of the predetermined machine on the 3D space.

3. The image processing device according to claim 2, wherein
the display controller is configured to display, on the 3D model image, the action point information of the 3D model of the predetermined machine at each position in the movable range.

4. The image processing device according to claim 1, wherein
an orientation of the virtual viewpoint is set to a direction perpendicular to a line segment connecting the object and the 3D model of the predetermined machine.

5. The image processing device according to claim 1, wherein
the virtual viewpoint is set such that the action points are dispersed on the 3D model image.

6. The image processing device according to claim 1, wherein
a position of the virtual viewpoint includes a position on the 3D space corresponding to a position of a person in the captured images acquired by the imaging devices.

7. The image processing device according to claim 1, wherein
the virtual viewpoint is set by a user.

8. The image processing device according to claim 1, further comprising
a selector that selects the object as an object of interest that is an object to which attention is paid, wherein
the 3D model image includes an image captured when a 3D space including the object of interest selected by the selector and at least a part of the 3D model of the predetermined machine is imaged from the virtual viewpoint.

9. The image processing device according to claim 8, wherein
the selector selects the object of interest on a basis of a type of the object and the distance information.

10. The image processing device according to claim 1, wherein
the display controller also controls display of a synthesized image of a predetermined viewpoint generated by synthesizing the plurality of captured images.

11. The image processing device according to claim 10, wherein
the display controller is configured to highlight the object in the synthesized image.

12. The image processing device according to claim 10, wherein
a shielded region of the synthesized image is generated by synthesizing the plurality of captured images by alpha blending.

13. The image processing device according to claim 1, wherein
at least a part of the predetermined machine includes an attachment attached to an arm of the predetermined machine.

14. An image processing method comprising:
by an image processing device,
acquiring a plurality of captured images acquired by a plurality of imaging devices installed in a predetermined machine;
acquiring distance information indicating a distance from a distance measurement device that measures a distance between the distance measurement device and an object imaged by the imaging devices; and
controlling display of a 3D model image that is an image captured when a 3D space including the object and a 3D model of at least a part of the predetermined machine is imaged from a virtual viewpoint, so as to display action point information indicating an action point of the 3D model of the predetermined machine on the 3D space, the 3D model image being generated by using the plurality of captured images and the distance information.

15. A program that causes a computer to function as:
an image acquirer that acquires a plurality of captured images acquired by a plurality of imaging devices installed in a predetermined machine;
a distance acquirer that acquires distance information indicating a distance from a distance measurement device that measures a distance between the distance measurement device and an object imaged by the imaging devices; and
a display controller that controls display of a 3D model image that is an image captured when a 3D space including the object and a 3D model of at least a part of the predetermined machine is imaged from a virtual viewpoint, so as to display action point information indicating an action point of the 3D model of the predetermined machine on the 3D space, the 3D model image being generated by using the plurality of captured images acquired by the image acquirer and the distance information acquired by the distance acquirer.
